(19) United States
(12) Patent Application Publication
(10) Pub. No.: US 2026/0279784 A1
(43) Pub. Date: Sep. 17, 2026

(54) BATTERY CELLS WITH CATHODE ELECTRODES INCLUDING CARBON-COATED LITHIUM MANGANESE OXIDE

(71) Applicant: GM Global Technology Operations LLC, Detroit, MI (US)

(72) Inventors: Dewen KONG, Shanghai (CN); Seung-Woo Chu, Sterling Heights, MI (US); Haijing Liu, Shanghai (CN); Venkataramani Anandan, Cumming, GA (US); Xin Zhang, Shanghai (CN); George Cintra, Jamestown, RI (US)

(21) Appl. No.: 19/247,788

(22) Filed: Jun. 24, 2025

(30) Foreign Application Priority Data
Mar. 13, 2025 (CN) 2025102996710

(51) Int. Cl. H01M 4/505; H01M 4/36; H01M 4/525; H01M 4/587; H01M 4/62; H01M 50/46

(52) U.S. Cl. CPC H01M 4/505; H01M 4/366; H01M 4/525; H01M 4/587; H01M 4/623; H01M 50/46

(57) ABSTRACT

A battery cell includes C cathode electrodes including a cathode active material layer arranged on a cathode current collector. The cathode active material layer includes LiMn₂O₄ (LMO) particles with a carbon coating to form carbon-coated LMO (C-LMO) particles or a blend of the C-LMO particles and LiNiCoMnO₂ (NCM) particles. The C-LMO particles comprise greater than 20 wt % of the blend. The battery cell includes A anode electrodes including an anode active material layer arranged on an anode current collector and S separators, where C, A, and S are integers greater than one. The carbon coating on the C-LMO particles comprises 0.1 wt % to 10 wt % of the C-LMO particles. The C-LMO particles can be doped with one or more dopants selected from a group consisting of titanium (Ti), magnesium (Mg), aluminum (Al), and niobium (Nb).

### CROSS-REFERENCE TO RELATED APPLICATIONS

This application claims the benefit of Chinese Patent Application No. 202510299671.0, filed on Mar. 13, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells with cathode electrodes including carbon-coated lithium manganese oxide.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes including a cathode active material layer arranged on a cathode current collector; A anode electrodes including an anode active material layer arranged on an anode current collector; and S separators, where C, A, and S are integers greater than one. The cathode active material layer includes a cathode active material comprising LiMn₂O₄ (LMO) particles coated with a carbon coating to form carbon-coated LMO (C-LMO) particles.

In other features, the LMO particles are doped with one or more dopants selected from a group consisting of titanium (Ti), magnesium (Mg), aluminum (Al), and niobium (Nb). The carbon coating on a surface of the LMO particles is one of continuous and discontinuous. The carbon coating comprises 0.1 wt % to 10 wt % of the C-LMO particles. The cathode active material layer includes the C-LMO particles blended with LiNiCoMnO₂ (NCM) particles.

In other features, the NCM particles have nickel content greater than 50%. The blend includes greater than 20% C-LMO particles. The blend includes greater than or equal to 50% C-LMO. The cathode active material layer includes the cathode active material in a range from 90% to 97%, a conductive additive in a range from 1 wt % to 5 wt %, and a binder in a range from 1 wt % to 5 wt %. The binder is selected from a group consisting of polyvinylidene fluoride (PVDF), polytetrafluoroethylene (PTFE), poly(vinylidene fluoride-co-hexafluoropropylene) (PVDF-HFP), and combinations thereof.

In other features, the anode active material layer includes an anode active material in a range from 90% to 99%, a conductive additive in a range from 1 wt % to 6 wt %, and a binder in a range from 0 to 3 wt %. The anode active material comprises artificial graphite. The anode active material comprises a blend of artificial graphite and natural graphite.

A battery cell includes C cathode electrodes including a cathode active material layer arranged on a cathode current collector. The cathode active material layer includes a blend of cathode active materials including LiMn₂O₄ (LMO) particles coated with a carbon coating to form carbon-coated LMO (C-LMO) particles and LiNiCoMnO₂ (NCM) particles. The C-LMO particles comprise greater than 20 wt % of the blend. The battery cell includes A anode electrodes including an anode active material layer arranged on an anode current collector and S separators, where C, A, and S are integers greater than one. The carbon coating on the C-LMO particles comprises 0.1 wt % to 10 wt % of the C-LMO particles.

In other features, the C-LMO particles include one or more dopants selected from a group consisting of titanium (Ti), magnesium (Mg), aluminum (Al), and niobium (Nb). The NCM has a nickel content greater than 50%. The blend comprises greater than 50 wt % of the C-LMO particles. The cathode active material layer includes the cathode active material in a range from 90% to 97%, a conductive additive in a range from 1 wt % to 5 wt %, and a binder in a range from 1 wt % to 5 wt %. The binder is selected from a group consisting of polyvinylidene fluoride (PVDF), polytetrafluoroethylene (PTFE), poly(vinylidene fluoride-co-hexafluoropropylene) (PVDF-HFP), and combinations thereof.

In other features, the anode active material layer includes anode active material in a range from 90% to 99%, a conductive additive in a range from 1 wt % to 6 wt %, and a binder in a range from 0 to 3 wt %, and the anode active material comprises artificial graphite. The anode active material comprises a blend of the artificial graphite and natural graphite.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C cathode electrodes including carbon-coated LiMn₂O₄ (LMO), A anode electrodes, and S separators according to the present disclosure;

FIG. 2A is a side cross section of an example of one of the C cathode electrodes according to the present disclosure;

FIG. 2B is a side cross section of an example of one of the A anode electrodes according to the present disclosure;

FIGS. 3A to 3D are side cross sections of examples of the cathode active material; and

FIG. 4 is a graph illustrating voltage as a function of specific capacity for a coin battery cell according to the present disclosure.

In the drawings, reference numbers may be reused to identify similar and/or identical elements.

### DETAILED DESCRIPTION

While battery cells are described herein in the context of rechargeable energy storage systems for vehicles, the battery cells can be used in other mobile or stationary applications.

Battery cells with cathode electrodes including LiMn₂O₄ (LMO) as the cathode active material can provide high nominal cell voltage, high thermal stability, low toxicity, and good safety at low cost in lithium-ion batteries. However, these battery cells suffer from capacity fading caused by a combination of structural transformation and dissolution of manganese (Mn). For example, capacity retention of battery cells using LMO may decrease to less than 80% after about 250 cycles and less than 60% after 1000 cycles.

Battery cells according to the present disclosure include cathode electrodes including carbon-coated LMO (C-LMO) or a blend of C-LMO and LiNiCoMnO₂ (NCM) as the cathode active material. The carbon coating of the C-LMO cathode active material isolates an interface between surfaces of the LMO particles and liquid electrolyte. The carbon interface suppresses Mn dissolution and improves cycle life and calendar life. In some examples, battery cells including cathode electrodes with a blend of C-LMO and NCM in a prismatic format achieve high energy density (e.g., greater than 550 Watts hours per liter (Wh/L)).

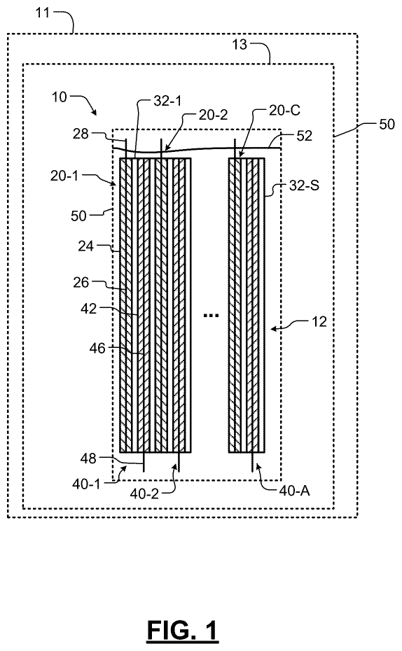

Referring now to FIG. 1, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50 (e.g., a prismatic, cylindrical, or pouch enclosure) that is at least partially filled with liquid electrolyte 52.

The C cathode electrodes 20-1, 20-2, . . . , and 20-C include a cathode active material layer 24 arranged on one or both sides of a cathode current collector 26. The A anode electrodes 40-1, 40-2, . . . , and 40-A include an anode active material layer 42 arranged one or both sides of an anode current collector 46. During charging/discharging, the A anode electrodes 40 and the C cathode electrodes 20 exchange lithium ions.

In some examples, the cathode active material layers 24 and/or the anode active material layers 44 comprise coatings including one or more active materials, one or more conductive additives, and/or one or more binder materials that are cast or applied onto the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2A, one of the C cathode electrodes 20 is shown in further detail. The cathode active material layer 24 includes one or more cathode active materials 70, a conductive additive 72, and a binder 74. In some examples, the cathode active material layer includes a first cathode active material including carbon-coated LiMn₂O₄ (LMO) or a blend of C-LMO and LiNiCoMnO₂ (NCM).

In some examples, the LMO is doped using one or more dopants. In some examples, the dopant includes one or more dopants selected from a group consisting of titanium (Ti), magnesium (Mg), aluminum (Al), and niobium (Nb). In some examples, the carbon coating comprises 0.1 wt % to 10 wt % of the coated particles.

In some examples, Brunauer, Emmett and Teller (BET) surface area of the cathode electrode is in a range from 0.2 m²/g to 10 m²/g. In some examples, BET is in a range from 0.5 m²/g to 1 m²/g. In some examples, tap density is greater than 1.5 cc. In some examples, the tap density is in a range from 1.8 cc to 2.2 cc.

In some examples, the C-LMO is blended with LiNiCoMnO₂ (NCM). In some examples, the NCM has a nickel content greater than 50%. In some examples, D50 particle size of the cathode active material is in a range from 2 μm to 15 μm. In some examples, BET surface area is in a range from 0.3 m²/g to 3 m²/g. In some examples, tap density is in a range from 2 g/cc to 3 g/cc.

In some examples, the cathode active material layer includes 100% carbon-coated LMO. In other examples, the cathode active material layer includes greater than 20% carbon-coated LMO and less than 80% NCM. In other examples, the cathode active material layer includes greater than 50% carbon-coated LMO and less than 50% NCM.

In some examples, the cathode active material layer includes cathode active material in a range from 90% to 97%, a conductive additive in a range from 1 wt % to 5 wt %, and a binder in a range from 1 wt % to 5 wt %. In some examples, the conductive additive is selected from a group consisting of Super P (SP), KS6, graphite, graphene nanoplates, single walled carbon nanotubes (SWCNT), multi-walled carbon nanotubes (MWCNT), etc.

In some examples, the cathode electrode has capacity loading in a range from 2 mAh/cm² to 8 mAh/cm² for a single-sided coating at 0.1 C. at room temperature. In some examples, press density is in a range from 2 g/cm³ to 4 g/cm³ and porosity is in a range from 22% to 50%.

In some examples, the binder comprises polyvinylidene fluoride (PVDF), polytetrafluoroethylene (PTFE), or poly(vinylidene fluoride-co-hexafluoropropylene) (PVDF-HFP). In some examples, a non-aqueous solvent is used during coating.

Referring now to FIG. 2B, one of the A anode electrodes 40 is shown in further detail. The anode active material layer 42 includes one or more anode active materials 80, a conductive additive 82, and a binder 84. In some examples, the anode active material layer includes artificial graphite (AG)-type graphite and/or natural graphite (NG)-type graphite. In some examples, the anode particles have a D50 size in a range from 6 μm to 20 μm and BET in a range from 0.1 m²/g to 10 m²/g.

In some examples, the anode particles have a D50 size in a range from 6 μm to 20 μm and BET surface area in a range from 0.1 m²/g to 10 m²/g. In some examples, the anode active material includes 100% of either the NG-type graphite or the AG-type graphite. In other examples, the anode active material layer includes a blend.

In some examples, the anode active material layer includes anode active material in a range from 90% to 99%, a conductive additive in a range from 1 wt % to 6 wt %, and a binder in a range from 0 to 3 wt %. In some examples, the conductive additive is selected from a group consisting of Super P (SP), graphite, graphene nanoplates, single walled carbon nanotubes (SWCNT), multi-walled carbon nanotubes (MWCNT), etc. In some examples, the binder is selected from a group including SNR and CMC, CMC/SBR/PAA, CMC and PAA, or PAA. In some examples, an aqueous solvent is used during coating.

In some examples, the anode electrode has capacity loading in a range from 2.2 to 8.5 mAh/cm² for a single-sided coating at 0.1 C. at room temperature. In some examples, press density is in a range from 1.3 g/cm³ to 1.9 g/cm³.

In some examples, the N/P ratio is in a range from 1 to 1.2. In some examples, the voltage output of the battery cell is in a range from 2.7V to 4.2V. In some examples, the battery cell has a stacked or winding structure and is arranged in a pouch, prismatic, or cylindrical enclosure.

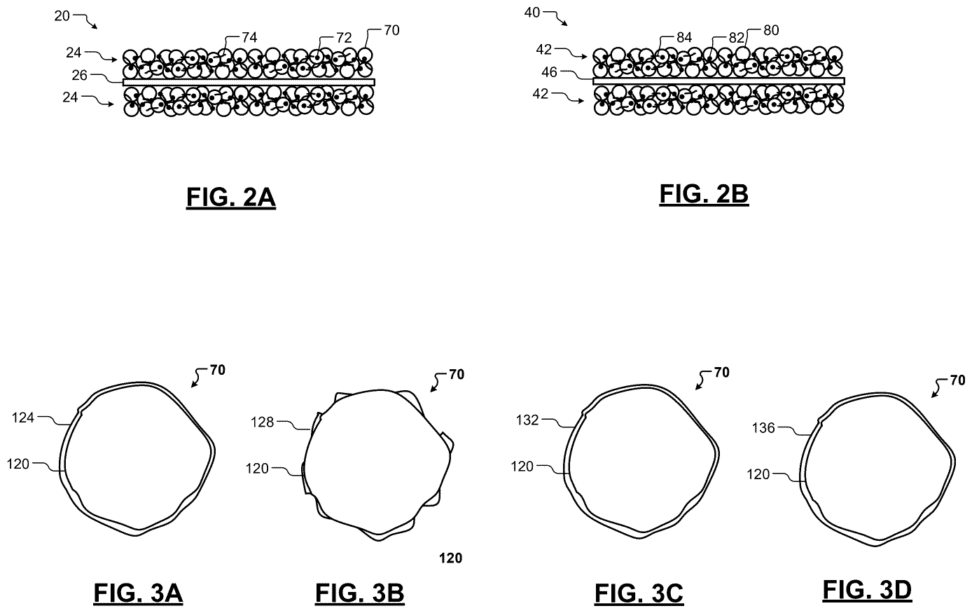

Referring now to FIGS. 3A to 3D, the cathode active material 70 is shown in further detail. In FIG. 3A, the cathode active material 70 includes core particles 120 comprising LMO and a continuous carbon coating 124 including carbon particles. In some examples, the carbon particles include SP and/or KB. In FIG. 3B, the cathode active material 70 includes core particles 120 comprising LMO and a discontinuous carbon coating 128 including carbon particles. In some examples, the carbon particles include SP, KB, and/or graphene.

In FIG. 3C, the cathode active material 70 includes core particles 120 comprising LMO and a chemical vapor deposition (CVD)-generated carbon coating 132 including carbon particles. In FIG. 3D, the cathode active material 70 includes core particles 120 comprising LMO and a carbon layer 136 deposited using pitch-generated carbon. Battery cells using carbon-coated LMO suppress Mn dissolution and enhance cycle life.

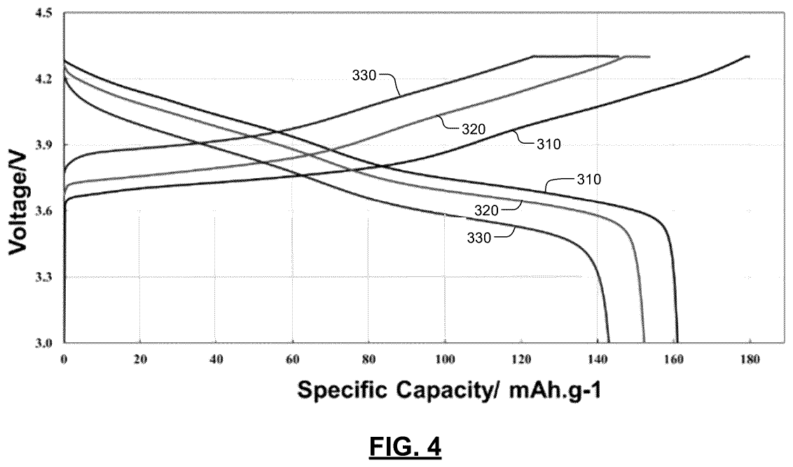

Referring now to FIG. 4, a graph illustrates voltage as a function of specific capacity for a coin cell. The cathode active material includes NCM-622 and LMO having an 8:2 ratio. The battery cell has a voltage output in a range from 3V to 4.3V and a capacity loading of 2 mAh/cm². The battery cell is shown during an initial cycle at a 0.2 C rate at 310, a 1 C rate at 320, and a 3 C rate at 330.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A battery cell comprising:
C cathode electrodes including a cathode active material layer arranged on a cathode current collector;
A anode electrodes including an anode active material layer arranged on an anode current collector; and
S separators, where C, A, and S are integers greater than one,
wherein the cathode active material layer includes a cathode active material comprising LiMn₂O₄ (LMO) particles coated with a carbon coating to form carbon-coated LMO (C-LMO) particles.

2. The battery cell of claim 1, wherein the LMO particles are doped with one or more dopants selected from a group consisting of titanium (Ti), magnesium (Mg), aluminum (Al), and niobium (Nb).

3. The battery cell of claim 1, wherein the carbon coating on a surface of the LMO particles is one of continuous and discontinuous.

4. The battery cell of claim 2, wherein the carbon coating comprises 0.1 wt % to 10 wt % of the C-LMO particles.

5. The battery cell of claim 1, wherein the cathode active material layer includes the C-LMO particles blended with LiNiCoMnO₂ (NCM) particles.

6. The battery cell of claim 5, wherein the NCM particles have nickel content greater than 50%.

7. The battery cell of claim 5, wherein the blend includes greater than 20% C-LMO particles.

8. The battery cell of claim 5, wherein the blend includes greater than or equal to 50% C-LMO.

9. The battery cell of claim 1, wherein the cathode active material layer includes the cathode active material in a range from 90% to 97%, a conductive additive in a range from 1 wt % to 5 wt %, and a binder in a range from 1 wt % to 5 wt %.

10. The battery cell of claim 9, wherein the binder is selected from a group consisting of polyvinylidene fluoride (PVDF), polytetrafluoroethylene (PTFE), poly(vinylidene fluoride-co-hexafluoropropylene) (PVDF-HFP), and combinations thereof.

11. The battery cell of claim 1, wherein the anode active material layer includes an anode active material in a range from 90% to 99%, a conductive additive in a range from 1 wt % to 6 wt %, and a binder in a range from 0 to 3 wt %.

12. The battery cell of claim 11, wherein the anode active material comprises artificial graphite.

13. The battery cell of claim 11, wherein the anode active material comprises a blend of artificial graphite and natural graphite.

14. A battery cell comprising:
C cathode electrodes including a cathode active material layer arranged on a cathode current collector,
wherein the cathode active material layer includes a blend of cathode active materials including:
LiMn₂O₄ (LMO) particles coated with a carbon coating to form carbon-coated LMO (C-LMO) particles; and
LiNiCoMnO₂ (NCM) particles, and
wherein the C-LMO particles comprise greater than 20 wt % of the blend;
A anode electrodes including an anode active material layer arranged on an anode current collector; and
S separators, where C, A, and S are integers greater than one,
wherein the carbon coating on the C-LMO particles comprises 0.1 wt % to 10 wt % of the C-LMO particles.

15. The battery cell of claim 14, wherein the C-LMO particles include one or more dopants selected from a group consisting of titanium (Ti), magnesium (Mg), aluminum (Al), and niobium (Nb).

16. The battery cell of claim 14, wherein the NCM has a nickel content greater than 50%.

17. The battery cell of claim 14, wherein the blend comprises greater than 50 wt % of the C-LMO particles.

18. The battery cell of claim 14, wherein:
the cathode active material layer includes the cathode active material in a range from 90% to 97%, a conductive additive in a range from 1 wt % to 5 wt %, and a binder in a range from 1 wt % to 5 wt %, and
the binder is selected from a group consisting of polyvinylidene fluoride (PVDF), polytetrafluoroethylene (PTFE), poly(vinylidene fluoride-co-hexafluoropropylene) (PVDF-HFP), and combinations thereof.

19. The battery cell of claim 14, wherein:
the anode active material layer includes anode active material in a range from 90% to 99%, a conductive additive in a range from 1 wt % to 6 wt %, and a binder in a range from 0 to 3 wt %, and
the anode active material comprises artificial graphite.

20. The battery cell of claim 14, wherein:
the anode active material comprises a blend of the artificial graphite and natural graphite.
